(19) United States
(12) Patent Application Publication
(10) Pub. No.: US 2025/0371350 A1
(43) Pub. Date: Dec. 4, 2025

(54) ANALYZING AND ADJUSTING AN ARTIFICIAL NEURAL NETWORK

(71) Applicant: STMicroelectronics International N.V., Geneva (CH)

(72) Inventors: Pierre Demaj, Nice (FR); Victor Felipe Domingues Do Amaral, Nice (FR)

(21) Appl. No.: 19/193,818

(22) Filed: Apr. 29, 2025

(30) Foreign Application Priority Data
Jun. 3, 2024 (FR) FR2405806

(51) Int. Cl. G06N 3/082

(52) U.S. Cl. CPC G06N 3/082

(57) ABSTRACT

In embodiments, a computer-implemented method is proposed for analyzing an already-trained artificial neural network to fine-tune it, the artificial neural network having a succession of layers, each layer having a parameter tensor, the method comprising: extracting a piece of Fisher information for each parameter of the artificial neural network, calculating an index for each layer of the artificial neural network, this index being representative of the pieces of Fisher information calculated for the parameters of this layer, defining a combination of layers to be fine-tuned of the artificial neural network, the combination of layers being defined from parameter tensor indices of the layers of the artificial neural network, comparing the memory occupation required for the fine-tuning of the parameters of the combination of layers and a maximum memory occupation threshold.

### CROSS-REFERENCE TO RELATED APPLICATIONS

This application claims priority to French Application No. 2405806, filed on Jun. 3, 2024, which application is hereby incorporated by reference herein in its entirety.

### TECHNICAL FIELD

Embodiments and implementations relate to artificial neural networks and, more particularly, the fine-tuning of artificial neural networks.

### BACKGROUND

Artificial neural networks are machine learning models. Artificial neural networks generally comprise a succession of neuron layers. Each layer takes, as input, data to which weights are applied and delivers, as output, data output after processing by functions for activating the neurons of the layer. These output data (also referred to as “activations”) are transmitted to the following layer in the neural network.

The weights are parameters of neurons that can be configured to obtain good data at the output of the layers. The weights of a layer are defined in a weight tensor.

The weights are fine-tuned during training (“learning phase”). This training is generally supervised, in particular, by executing the neural network based on already classified input data from the reference database. This training phase allows a trained neural network to be obtained.

It is common that the data acquired after deployment of an artificial neural network are substantially different from those used for its initial training.

More specifically, the data used during the training may not sufficiently represent the data taken as input for the neural network after its deployment. More specifically, when the training data originates from a specific context that differs significantly from that encountered during actual use, this can lead to notable deviations in performance. These deviations may be manifest in the form of bias, insufficient generalization, or loss of precision.

### SUMMARY

In embodiments, the neural network can originate from a library of artificial neural networks. Such a neural network can be trained with general learning data. These general learning data may not represent the data acquired in the environment in which the neural network will be deployed. Thus, the precision of the neural network trained with the general learning data may be reduced.

It is, therefore, preferable to fine-tune the neural network's parameters to improve the neural network's precision. The fine-tuning has the advantage of avoiding retraining the entire neural network by limiting the training to certain neural network parameters. In particular, total retraining is not always possible when a memory-constrained computer system performs the retraining.

The fine-tuning can reduce the memory and computing capacity requirements for training the neural network. This is particularly important when the fine-tuning of the neural network is carried out by the computer system in which the neural network is deployed. More specifically, such a computer system may have limited energy consumption, memory, and calculation capacities.

The fine-tuning of a neural network by a computer system in which this neural network is deployed has several advantages. Such fine-tuning makes it possible to avoid communication of the data acquired by this computer system to outside of it to fine-tune the neural network. This makes it possible to reduce the energy consumption of the computer system on which the neural network is deployed while ensuring the confidentiality of the acquired data and the fine-tuned neural network.

It is possible, in particular, to authorize the fine-tuning of certain parameters and to keep the value of certain other parameters. For example, the fine-tuning of the neural network may seek to fine-tune the N last layers and conserve the other layers of the neural network.

However, the layers of the neural network can have a variable impact on the performance of the neural network. It is therefore not always relevant to choose to fine-tune the N last layers of the neural network, in particular from a point of view of precision of the fine-tuned neural network and the memory occupation required for the fine-tuning of the neural network.

Thus, it is advantageous to understand and analyze each layer's specific contribution to the neural network's general task. Identifying the layers related to performance makes it possible to concentrate the efforts for fine-tuning the neural network where they will be most beneficial. By optimizing these strategic layers, the neural network's performance can be significantly improved without requiring a complete retraining.

The publication “On-Device training Under 256KB Memory”, Ji Lin et al., 2022, describes a method for sparse updating (designated by the expression “Sparse update method”) for determining the layers of the neural network having the most impact on the output of the neural network. In particular, this method can extract a gain in performance obtained by each layer of the neural network in such a way as to study the contribution of each layer in the output of the neural network.

This method has the disadvantages of being complex to implement and requiring a significant quantity of data to fine-tune a neural network.

There is, therefore a need to propose a solution for simple and fast fine-tuning of a trained neural network.

According to one aspect, the disclosure relates to a computer-implemented method for analyzing an already-trained artificial neural network to fine-tune it, the artificial neural network having a succession of layers, each layer having a parameter tensor, the method comprising: extracting a piece of Fisher information for each parameter of the neural network, calculating a parameter tensor index for each layer of the neural network, this index being representative of the pieces of Fisher information extracted from the parameters of this layer, defining a combination of layers to be fine-tuned of the artificial neural network, the combination of layers being defined from parameter tensor indices of the layers of the artificial neural network, comparing the memory occupation required for the fine-tuning of the parameters of the combination of layers and a maximum memory occupation threshold, and modifying the combination of layers to be fine-tuned if the memory occupation required for the fine-tuning of the parameters of the combination of layers is greater than the maximum memory occupation threshold.

The Fisher information makes it possible to evaluate, in a simple and fast manner, the importance of a parameter on the neural network's output. The Fisher information is then used to define a parameter tensor index for each layer of the artificial neural network. This index makes it possible to evaluate the impact of each layer on the output of the artificial neural network to define the combination of layers to be fine-tuned.

Fisher's information can be estimated from a low amount of learning data. This makes it possible to avoid supplying all of a set of learning data for analyzing the already-trained neural network.

The fact of verifying whether the memory occupation required for a fine-tuning of a combination of layers is less than a memory occupation threshold, makes it possible to avoid choosing a combination of layers for which a fine-tuning could not be carried out because of exceeding the possible memory occupation threshold in a computer system having limited memory resources.

Advantageously, the index of a parameter tensor for a layer corresponds to the mean of the pieces of Fisher information associated with the parameters of this layer.

In an advantageous implementation, the definition of a combination of layers to be fine-tuned comprises searching for a combination of layers, making it possible to optimize the sum of the parameter tensor indices of the layers of the combination of layers while respecting the maximum memory occupation threshold.

Preferably, the definition of a combination of layers to be fine-tuned comprises implementing an optimization algorithm configured to build a combination of layers by iterations. The combination of layers to be fine-tuned thus corresponds to the last combination of layers defined at the end of a predefined number of iterations.

In an advantageous embodiment, the optimization algorithm is configured to build a combination of layers by iterations from: parameter tensor indices of the layers of the neural network, an objective function corresponding to the sum of the parameter tensor indices of the preceding combination of defined layers, an objective function corresponding to the difference between the maximum memory occupation threshold and the memory occupation required for the fine-tuning of the preceding combination of defined layers.

Advantageously, the optimization algorithm is a non-dominated sorting genetic algorithm.

Advantageously, the memory occupation required for the fine-tuning of a combination of layers of the artificial neural network is evaluated from a size of the parameters of the neural network, a size of the output data of each layer of the artificial neural network, the quantity and size of the learning data used for the fine-tuning and an indication on the use of a momentum for the fine-tuning.

In embodiments, the maximum memory occupation threshold is entered via a command line or a graphical interface.

In an advantageous implementation, the last combination of layers defined is stored in a file configured to be read by a computer to produce a fine-tuning of the parameters of the layers of the last defined combination of layers of the neural network.

According to another aspect, the disclosure relates to a method for fine-tuning an already-trained neural network comprising a fine-tuning of the parameters of the layers of a defined combination of layers by implementing an analysis method as previously described.

According to another aspect, a method is proposed comprising: a method for analyzing an already-trained artificial neural network such as previously described, then a method for fine-tuning the artificial neural network as previously described.

According to another aspect, a computer program product is proposed comprising instructions which, when the program is executed by a computer, result in the latter implementing a method for analyzing an already-trained neural network as described previously.

According to another aspect, a computer program product is proposed comprising instructions which, when the program is executed by a computer, result in the latter implementing a method for fine-tuning an already-trained neural network as described previously.

According to another aspect, an information system is proposed comprising: a memory in which are stored an already-trained artificial neural network to be fine-tuned and a computer program as previously described, for analyzing the already-trained neural network, a processing unit configured to execute the computer program.

According to another aspect, an information system is proposed comprising: a memory in which are stored an already-trained artificial neural network to be fine-tuned and a computer program as previously described, for fine-tuning the already-trained neural network, a processing unit configured to execute the computer program.

### BRIEF DESCRIPTION OF THE DRAWINGS

Other advantages and features of the disclosure will become apparent upon reading the detailed description of embodiments, which are in no way limiting, and from the appended drawings in which:

FIG. 1 is a block diagram of an embodiment computer system configured to analyze an artificial neural network;

FIG. 2 is a flowchart an embodiment method for analyzing an artificial neural network;

FIG. 3 is a flowchart of an embodiment method for estimating the memory occupation for the fine-tuning of the layers of a combination of layers chosen by the optimization algorithm;

FIG. 4 is a block diagram of an embodiment computer system configured for fine-tuning an artificial neural network; and

FIG. 5 is a flowchart of an embodiment method for fine-tuning an already-trained artificial neural network which can be implemented by the computer system.

### DETAILED DESCRIPTION OF ILLUSTRATIVE EMBODIMENTS

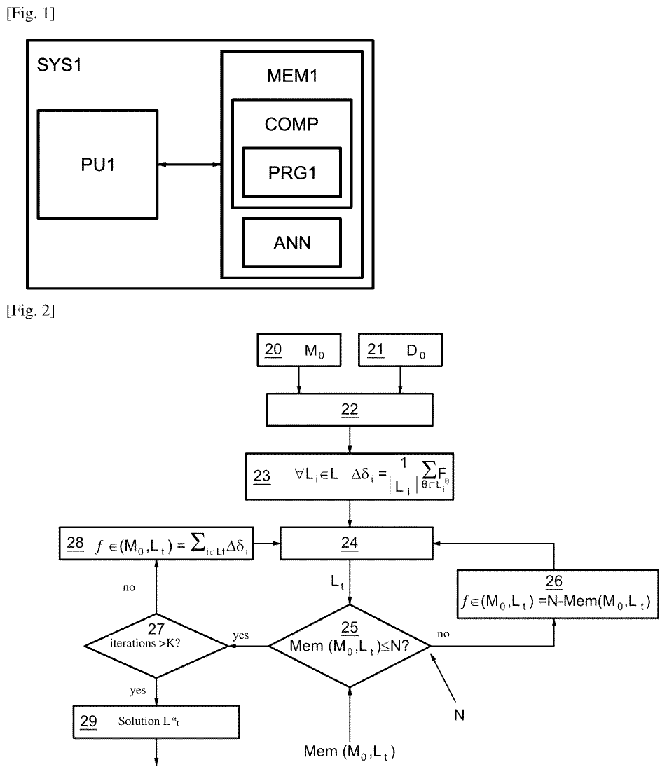

FIG. 1 illustrates a block diagram of an embodiment computer system SYS1 configured to analyze an artificial neural network. Such an information system SYS1 may be a personal computer or even a server, for example. The computer system comprises a processing unit SYS1 and a memory MEM1.

The memory MEM1 is configured to store an artificial neural network ANN. This artificial neural network ANN can be an already-trained artificial neural network. For example, the artificial neural network can be obtained from a library of artificial neural networks. Alternatively, the computer system SYS1 is configured to train the artificial neural network.

The memory MEM1 comprises a neural network compilation software COMP. The compilation software COMP is configured to analyze an already-trained artificial neural network ANN.

The compilation software COMP includes a computer program PRG1 comprising instructions which, when the program PRG1 is executed by the processing unit PU1 of the computer system SYS1, leads it to implement an analysis method of an artificial neural network such as that described below concerning FIG. 2.

FIG. 2 illustrates a flowchart of an embodiment method for analyzing an artificial neural network.

At step 20, a pre-trained artificial neural network ANN is obtained. In particular, such an artificial neural network can be pre-trained from general learning data, which differ from the data that will be processed by the artificial neural network once deployed. For example, the artificial neural network can be obtained from a library of artificial neural networks. The artificial neural network obtained can be stored in the memory MEM1 of the computer system SYS1.

An artificial neural network comprises a plurality of layers, each formed by at least one neuron, particularly by a plurality of neurons. The first layer of the artificial neural network is designated as the input layer. This input layer is configured to receive the data taken as input of the artificial neural network. The last layer is designated as the output layer. This output layer generates an output of the artificial neural network. The intermediate layers between the first and last layers can be designated as hidden layers. These hidden layers comprise of neurons that modify the data through activation functions. The complexity and the number of these hidden layers vary depending on the nature of the problem to be solved.

Weights and biases are defined as parameters of the artificial neural network for each layer of the artificial neural network.

The weights are coefficients that define the importance of each neuron input. These weights are fine-tuned during the learning phase to reduce the network's prediction error.

The biases are values added to the sum of the inputs to optimize the neuron's response depending on the data.

The weights and biases are stored in a parameter tensor. A parameter tensor is a structure that organizes its parameters according to their belonging to a specific layer and to a specific neuron within this layer.

At step 21, a set of learning data for fine-tuning the artificial neural network is obtained. These learning data represent the data that will be processed by the artificial neural network once deployed. These learning data can be obtained by a sensor in the environment where the artificial neural network will be deployed. The set of learning data may consist of only a part of the learning data that will be used for fine-tuning the artificial neural network.

At step 22, a piece of Fisher information is extracted for each parameter of the artificial neural network. In particular, a piece of Fisher information can be calculated for each weight and each bias of the artificial neural network.

The piece of Fisher information makes it possible to evaluate the importance of a parameter on the output of the artificial neural network. In particular, for an artificial neural network and a given parameter of this artificial neural network, p_{θ}(y|x) designates the conditional probability function of output of the artificial neural network, where θ is the parameter of the neural network, y is the output vector of the artificial neural network, and x is the input vector of the artificial neural network. This output probability can be obtained by executing the neural network several times while varying the input vector x for a given class and varying the class of x to obtain the expectation of the output vector y knowing x.

In this case, the piece of Fisher information of the parameter can be approximated by the following mathematical formula: F_{θ}= [symbol] ₓ [symbol] _{y˜p}_{_{θ}}_{(y|x)}(∇_{θ} log (p_{θ}(y|x))²), where [symbol] ₓ is the expectation on x, [symbol] _{y˜p}_{_{θ}}_{(y|x)} is the expectation on y distributed according to the conditional probability function p_{θ}(y|x), ∇_{θ} log (p_{θ}(y|x) is the log of the gradient of the conditional probability with respect to the parameter θ.

The Fisher information can be estimated from a low number of learning data. This makes it possible to avoid supplying the entirety of a set of learning data.

At step 23, one index per parameter tensor of each layer is calculated—the index being representative of the pieces of Fisher information extracted for the parameters of this layer. This step makes it possible to reduce the pieces of Fisher information of the parameters of the artificial neural network to one index for each layer.

In particular, for each layer of the artificial neural network, the index of the parameter tensor of this layer is calculated. This index can be obtained by averaging the pieces of Fisher information of the parameters of the layer. Thus, the index of the tensor of a layer can be obtained by applying the following mathematical formula:

$${Δδ}_{i} = \frac{1}{\vert {L}_{i} \vert} {\sum }_{θ ∈ {L}_{i}} {F}_{θ} ,$$

where Δδᵢ is the index of the tensor of the layer Lᵢ, |Lᵢ| corresponds to the number of parameters in the layer Lᵢ, and F_{θ} is the piece of Fisher information of the parameter θ.

Alternatively, other calculations can be used to calculate the index of a parameter tensor of a layer. For example, this index can be obtained by summing the pieces of Fisher information of the parameters of the layer, or else by calculating a “LogSumExp” function (also known by the abbreviation “LSE”).

This index enables an estimation of the correlation between the parameters of the layer and the output of the artificial neural network.

Thus, the index of the parameter tensor of a layer makes it possible to evaluate the importance of the layer concerning the output of the artificial neural network and, thus, to evaluate the interest in fine-tuning this layer. This index makes it possible to evaluate the impact of each layer on the output of the artificial neural network. In particular, the greater the impact of a layer on the output of the artificial neural network, the higher its index.

Subsequently, the method seeks to find a combination of layers that can optimize the sum of the parameter tensor indices of these layers while respecting a memory occupation constraint for fine-tuning the layers of this combination. The method makes it possible to test a plurality of combinations of layers. The tested combinations of layers are referred to below as temporary. The method, therefore, comprises a plurality of iterations, making it possible to test a different temporary combination of layers for each iteration. In embodiments, the method comprises defining a maximum number K of iterations.

At step 24, a combination Lₜ of temporary layers is defined. This set Lₜ of temporary layers can be determined by executing an optimization algorithm, in particular, an evolutionary algorithm. The optimization algorithm can, in particular, be a non-dominated sorting genetic algorithm-II (generally designated by the abbreviation “NSGA-II”). Alternatively, it is possible to use other optimization algorithms. For example, it is possible to use an algorithm chosen from the “NSGA-III” algorithm and the “SPEA-2” algorithm (Strength Pareto Evolutionary Algorithm 2). The optimization algorithm can also be a combinatory optimization algorithm, such as the “Ant Colony” algorithm or the “Particle Swarm Optimization” algorithm.

This optimization algorithm is configured to define a temporary combination of layers by choosing layers of the artificial neural network. This makes it possible to maximize a sum of the indices Δδᵢ; of the parameter tensors of the chosen layers while avoiding exceeding a memory occupation threshold defined by the user.

The fact of verifying whether the memory occupation required for a fine-tuning of a temporary combination of layers is less than a memory occupation threshold, makes it possible to avoid choosing a combination of layers for which a fine-tuning could not be carried out because of exceeding the possible memory occupation threshold in a computer system having limited memory resources.

Implementing an optimization algorithm increases the chances of finding an optimum combination of layers to be fine-tuned.

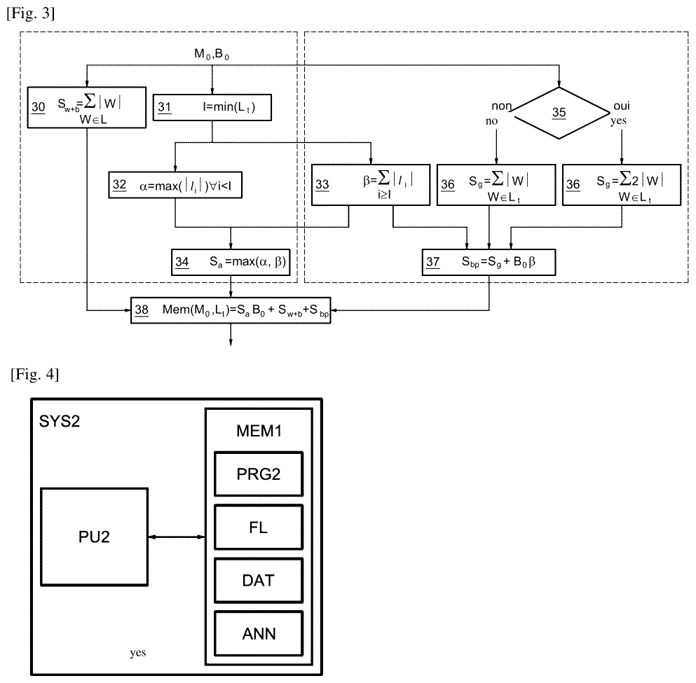

Once the optimization algorithm defines a temporary combination of layers, the method evaluates the memory occupation for fine-tuning the chosen layers. The evaluation of the memory occupation is described in conjunction with FIG. 3.

At step 25, the memory occupation for fine-tuning the chosen layers is compared with the memory occupation threshold. Users can enter this memory occupation threshold via a command line or a graphical interface.

If the occupation of the memory for the training of the chosen layers exceeds the memory occupation threshold, at step 26, an objective function is defined considering this memory occupation. This objective function can be defined by the following mathematical formula: f(M₀, Lₜ)=N−Mem(M₀, Lₜ).

The result of this objective function is taken as input for the optimization algorithm. In this way, the optimization algorithm will attempt to find a temporary combination of layers for which the memory occupation of the training of the chosen layers will be less than or equal to the memory occupation threshold.

If at step 25, the occupation of the memory for the training of the chosen layers is less than or equal to the memory occupation threshold, at step 27, a test is used to verify whether the number of iterations of the optimization algorithm is greater than the maximum number K of iterations.

If the number of iterations of the optimization algorithm is less than or equal to the maximum number K of iterations, then the method comprises step 28, where an objective function is defined considering the index of the parameter tensors of the layers of the chosen temporary combination Lt of layers. This objective function can be defined by the following mathematical formula: f(M₀, Lₜ)=Σ_{i∈L}_{ₜ}Δδᵢ.

The result of this objective function is taken as input for the optimization algorithm. In this way, the optimization algorithm will attempt to find a temporary combination of layers for which the index of the parameter tensors of the chosen layers is the highest.

If, in step 27, the number of iterations of the optimization algorithm is greater than the maximum number K of iterations, at step 29, a final combination of layers is defined. This final combination of layers corresponds to the last temporary combination of layers defined.

This final combination of layers corresponds to the combination of layers having the highest index of parameter tensors among the temporary sets of layers tested, and for which the memory occupation for the training of the chosen layers is less than the threshold defined by the user.

In embodiments, the processing unit PU1 can generate a file that can indicate the layers of the final combination of layers. This file can then be used for the fine-tuning of the artificial neural network.

FIG. 3 illustrates a flowchart of an embodiment method for estimating the memory occupation for fine-tuning the layers of a combination of layers chosen by the optimization algorithm.

The method takes, as input, the artificial neural network and the batch size of learning data taken as input of the artificial neural network. The batch size corresponds to the number of samples of learning data which is taken as input of the artificial neural network for calculating the gradients enabling updating of the parameters of the neural network (weights and biases).

The artificial neural network to be used and the batch size are specified by the user, via a command line or via a graphical interface, for example.

The method comprises estimating at step 30 the memory occupation of the set of parameters of the artificial neural network.

The memory occupation of the set of parameters of the artificial neural network is estimated by applying the following mathematical formula: S_{w+b}=Σ_{i in L}dim(Wᵢ)·W_{datatype}+dim(bᵢ)·b_{datatype}, where dim(Wᵢ) corresponds to the number of weights of the layer L, W_{datatype} is the number of bits or bytes used to represent a weight of the layer L, dim(bᵢ) corresponds to the number of biases in the layer L, and b_{datatype} is the number of bits or bytes used to represent a bias of the layer L.

The method also comprises obtaining at step 31 the deepest layer from the combination of layers defined by the optimization algorithm. This layer can be obtained by applying the following mathematical formula: I=min(Lₜ), where min(Lₜ) corresponds to the smallest index of the temporary combination Lₜ of layers, in other words the index of the layer closest to the start of the artificial neural network.

Then, the method also comprises obtaining at step 32 the maximum size of output data of the layers deeper than layer I. This maximum size can be obtained by applying the following mathematical formula: α=max (|lᵢ|) ∀i<I, where lᵢ corresponds to the size of the output data of the layer i.

The method also comprises calculating at step 33 the sum of the sizes of the output data of the layer I and layers less deep than layer I. Thus, this sum can be obtained by applying the following mathematical formula: β=Σ_{i≥I}|lᵢ|, where lᵢ is the size of the output data of the layer i.

The method also comprises obtaining at step 34 a peak in memory occupation of the output data of the layers of the neural network. This peak in memory occupation can be obtained by applying the following mathematical formula: S_{α}=max (α, β).

The method also comprises a test at step 35. This test at step 35 is configured to determine whether a momentum is used for the fine-tuning of the artificial neural network. The momentum is an extension of the gradient descent optimization algorithm, well known to a person skilled in the art. The choice of using a momentum rests with the user. The user can, in particular, indicate whether or not he wishes to use a momentum via a command line or a graphical interface.

Then, the method comprises calculating at step 36 the memory occupation of the parameters of the layers of the combination of layers chosen by the optimization algorithm. This calculation depends on the result of the test at step 35.

If a momentum is not used to carry out the fine-tuning, then the memory occupation of the parameters of the layers of the combination of layers chosen can be calculated by summing the parameters of the layers. Thus, this memory occupation can be calculated according to the following mathematical formula: S_{g}=Σ_{W∈L}_{_{τ}}|W|, where |W| corresponds to the size of the parameters of each layer of the chosen combination of layers.

If a momentum is used to carry out the fine-tuning, then the memory occupation of the parameters of the layers of the combination of layers chosen, can be calculated by summing the parameters of the layers multiplied by two. Thus, this memory occupation can be calculated according to the following mathematical formula: S_{g}=Σ_{W∈L}_{_{τ}}2|W|, where |W| corresponds to the size of the parameters of each layer of the chosen combination of layers.

Then, the method comprises calculating 37 a memory occupation for the backpropagation performed during the fine-tuning of the artificial neural network. This occupation can be obtained by multiplying the batch size of the learning data by the sum of the output data of the layer I and of the layers less deep than layer I, then by adding the result of this multiplication to the memory occupation of the parameters of the layers of the chosen combination of layers. Thus, the memory occupation for the backpropagation can be calculated according to the following formula: S_{bp}=S_{g}+B₀β, where Bₒ is the batch size of learning data taken as input to the artificial neural network.

The method then comprises calculating 38 the memory occupation for the fine-tuning of the layers of the combination of layers chosen by the optimization algorithm. This memory occupation corresponds to the sum of the memory occupation for browsing the artificial neural network and of the memory occupation for the backpropagation during the fine-tuning. Thus, the memory occupation for the fine-tuning of the layers of the combination of layers chosen by the optimization algorithm can be calculated according to the following formula: Mem(M₀, Lₜ)=SₐB₀+S_{w+b}+S_{bp}.

FIG. 4 illustrates a block diagram of an embodiment computer system SYS2 configured for fine-tuning an artificial neural network. The computer system SYS2 may be a microcontroller, a personal computer, or a server, for example.

The computer system SYS2 comprises a processing unit PU2 and a memory MEM2.

The memory MEM2 is configured for storing an already-trained neural network ANN to be fine-tuned. This artificial neural network ANN has already been analysed by implementing an analysis method as previously described in conjunction with FIG. 2.

The memory MEM2 is also configured for storing a file FL obtained using the analysis method. This file indicates the final combination of layers to be used for the fine-tuning of the artificial neural network ANN. Alternatively, it is possible to store this combination of layers in the program, enabling the use of the artificial neural network ANN.

The memory MEM2 is also configured for storing a set DAT of learning data DAT for fine-tuning. Alternatively, this set DAT of learning data can be stored on a remote server. This set of learning data is different from the set of learning data used to analyse the artificial neural network. The set of learning data for the analysis of the artificial neural network can be a subset of data from the set of learning data.

The memory MEM2 also comprises a computer program PRG2 comprising instructions which, when they are executed by the processing unit PU2, causes the latter to carry out a method for fine-tuning the artificial neural network.

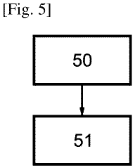

FIG. 5 illustrates an implementation of a method for fine-tuning an already-trained artificial neural network ANN which can be implemented by the computer system SYS2.

The method comprises obtaining 50 the artificial neural network ANN and a file FL indicating the final combination of layers to be used for the fine-tuning, as well as a set DAT of learning data for the fine-tuning.

The method then comprises a fine-tuning 51 of the parameters of the layers of the final combination of layers from the set of learning data. The fine-tuning of these parameters is carried out by performing a new training of the artificial neural network. In this new training, only the parameters of the layers of the final combination of layers defined in the file FL can be modified, the values of the other parameters remaining the same.

This fine-tuning makes it possible to obtain a fine-tuned artificial neural network, the performance of which is improved compared with the initial already-trained artificial neural network.

What is claimed is:

1. A method for analyzing an already-trained artificial neural network to fine-tune it, the method comprising:
extracting a piece of Fisher information for each parameter of the artificial neural network, wherein the artificial neural network has a succession of layers and each layer has a parameter tensor;
calculating a parameter tensor index for each layer of the artificial neural network, wherein the parameter tensor index is representative of the pieces of Fisher information extracted from the parameters of each respective layer;
defining a combination of layers of the artificial neural network to be fine-tuned, wherein the combination of layers is defined from parameter tensor indices of the layers of the artificial neural network;
comparing a memory occupation required for the fine-tuning of the parameters of the combination of layers and a maximum memory occupation threshold; and
modifying the combination of layers to be fine-tuned in response to the memory occupation required for the fine-tuning of the parameters of the combination of layers being greater than the maximum memory occupation threshold.

2. The method of claim 1, wherein the parameter tensor index for a layer corresponds to a mean of the pieces of Fisher information associated with the parameters of the layer.

3. The method of claim 2, wherein defining the combination of layers to be fine-tuned comprises searching for a combination of layers that optimizes a sum of the parameter tensor indices of the layers of the combination of layers, subject to the memory occupation required for fine-tuning remaining below the maximum memory occupation threshold.

4. The method of claim 2,
wherein defining the combination of layers to be fine-tuned comprises implementing an optimization algorithm configured to build a combination of layers by iterations, and
wherein the combination of layers to be fine-tuned corresponds to a last combination of layers defined at the end of a predefined number of iterations.

5. The method of claim 4, wherein the optimization algorithm is configured to build a combination of layers by iterations from:
parameter tensor indices of the layers of the neural network;
a first objective function corresponding to a sum of the parameter tensor indices of a preceding combination of defined layers; and
a second objective function corresponding to a difference between the maximum memory occupation threshold and the memory occupation required for the fine-tuning of the preceding combination of defined layers.

6. The method of claim 5, wherein the optimization algorithm is a non-dominated sorting genetic algorithm.

7. The method of claim 2, wherein the memory occupation required for the fine-tuning of the combination of layers of the artificial neural network is evaluated from a size of the parameters of the neural network, a size of output data of each layer of the artificial neural network, a quantity and size of learning data used for the fine-tuning, and an indication on use of a momentum for the fine-tuning.

8. A method for analyzing an already-trained artificial neural network, comprising:
extracting a piece of Fisher information for each parameter of the artificial neural network, wherein the artificial neural network has a succession of layers and each layer has a parameter tensor;
calculating a parameter tensor index for each layer of the artificial neural network, wherein the parameter tensor index corresponds to a mean of the pieces of Fisher information associated with the parameters of the layer;
defining a combination of layers of the artificial neural network to be fine-tuned by implementing an optimization algorithm configured to build a combination of layers by iterations, wherein the combination of layers to be fine-tuned corresponds to a last combination of layers defined at the end of a predefined number of iterations;
comparing a memory occupation required for the fine-tuning of the parameters of the combination of layers and a maximum memory occupation threshold, wherein the maximum memory occupation threshold is entered via a command line or a graphical interface; and
modifying the combination of layers to be fine-tuned in response to the memory occupation required for the fine-tuning of the parameters of the combination of layers being greater than the maximum memory occupation threshold.

9. The method of claim 8, wherein the optimization algorithm is configured to build a combination of layers by iterations from:
parameter tensor indices of the layers of the neural network;
a first objective function corresponding to a sum of the parameter tensor indices of a preceding combination of defined layers; and
a second objective function corresponding to a difference between the maximum memory occupation threshold and the memory occupation required for fine-tuning the preceding combination of defined layers.

10. The method of claim 9, wherein the optimization algorithm is a non-dominated sorting genetic algorithm.

11. The method of claim 8, wherein the memory occupation required for the fine-tuning of the combination of layers of the artificial neural network is evaluated from a size of the parameters of the neural network, a size of output data of each layer of the artificial neural network, a quantity and size of learning data used for the fine-tuning, and an indication on use of a momentum for the fine-tuning.

12. The method of claim 8, wherein a final combination of layers defined is stored in a file configured to be read by a computer to produce a fine-tuning of the parameters of the layers of the final defined combination of layers of the artificial neural network.

13. The method of claim 8, further comprising fine-tuning the parameters of the layers of the defined combination of layers of the artificial neural network.

14. The method of claim 8, wherein defining the combination of layers to be fine-tuned comprises searching for a combination of layers that optimizes a sum of the parameter tensor indices of the layers of the combination of layers, subject to the memory occupation required for fine-tuning remaining below the maximum memory occupation threshold.

15. A system for analyzing an already-trained artificial neural network, comprising:
a non-transitory memory storage comprising instructions and the already-trained artificial neural network; and
a processor in communication with the non-transitory memory storage, wherein the processor executes the instructions to:
extract a piece of Fisher information for each parameter of the artificial neural network, wherein the artificial neural network has a succession of layers and each layer has a parameter tensor;
calculate a parameter tensor index for each layer of the artificial neural network, wherein the parameter tensor index corresponds to a mean of the pieces of Fisher information associated with the parameters of the layer;
define a combination of layers of the artificial neural network to be fine-tuned by implementing an optimization algorithm configured to build a combination of layers by iterations, wherein the combination of layers to be fine-tuned corresponds to a last combination of layers defined at the end of a predefined number of iterations;
compare a memory occupation required for the fine-tuning of the parameters of the combination of layers and a maximum memory occupation threshold; and
modify the combination of layers to be fine-tuned in response to the memory occupation required for fine-tuning the parameters of the combination of layers being greater than the maximum memory occupation threshold.

16. The system of claim 15, wherein the optimization algorithm is configured to build a combination of layers by iterations from:
parameter tensor indices of the layers of the neural network;
a first objective function corresponding to a sum of the parameter tensor indices of a preceding combination of defined layers; and
a second objective function corresponding to a difference between the maximum memory occupation threshold and the memory occupation required for the fine-tuning of the preceding combination of defined layers.

17. The system of claim 16, wherein the optimization algorithm is a non-dominated sorting genetic algorithm.

18. The system of claim 15, wherein the memory occupation required for the fine-tuning of the combination of layers of the artificial neural network is evaluated from a size of the parameters of the neural network, a size of output data of each layer of the artificial neural network, a quantity and size of learning data used for the fine-tuning, and an indication on use of a momentum for the fine-tuning.

19. The system of claim 15, wherein a final combination of layers defined is stored in a file configured to be read by a computer to produce a fine-tuning of the parameters of the layers of the final defined combination of layers of the artificial neural network.

20. The system of claim 15, wherein the processor executes the instructions to fine-tune the parameters of the layers of the defined combination of layers of the artificial neural network.
